(19) United States
(12) Patent Application Publication
(10) Pub. No.: US 2026/0290907 A1
(43) Pub. Date: Sep. 24, 2026

(54) ELECTRODE ASSEMBLY AND SECONDARY BATTERY COMPRISING THE ELECTRODE ASSEMBLY

(71) Applicant: SAMSUNG SDI CO., LTD., Yongin-si (KR)

(72) Inventor: Young Kwang YUN, Yongin-si (KR)

(21) Appl. No.: 19/297,126

(22) Filed: Aug. 12, 2025

(30) Foreign Application Priority Data
Mar. 21, 2025 (KR) 10-2025-0036294

(51) Int. Cl. H01M 10/0587; H01M 10/052; H01M 50/105; B60L 50/64

(52) U.S. Cl. CPC H01M 10/0587; H01M 10/052; H01M 50/105; B60L 50/64; H01M 2220/20

(57) ABSTRACT

The electrode assembly according to the embodiment includes a first electrode; a second electrode; and a separator between the first electrode and the second electrode, the first electrode, the second electrode, and the separator are wound in one direction to form a core part, the first electrode comprises a first current collector, a first active material layer, and a first electrode tab, the second electrode comprises a second current collector, a second active material layer, and a second electrode tab, the first electrode tab comprises a first(a) electrode tab and a first(b) electrode tab, the second electrode tab comprises a second(a) electrode tab and a second(b) electrode tab, the first(a) electrode tab and the second(a) electrode tab are disposed furthest from the core part, and the first(a) electrode tab comprises a region with a regional width less than a tab width of the first(b) electrode tab.

### CROSS-REFERENCE TO THE RELATED APPLICATION

The present application claims priority to and the benefit of Korean Patent Application No. 10-2025-0036294, filed on March 21, 2025, in the Korean Intellectual Property Office, the entire disclosure of which is incorporated herein by reference.

### BACKGROUND

### Field

Embodiments relate to an electrode assembly and a secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide secondary battery having improved safety.

The electrode assembly according to the embodiment includes a first electrode; a second electrode; and a separator between the first electrode and the second electrode, the first electrode, the second electrode, and the separator are wound in one direction to form a core part, the first electrode comprises a first current collector, a first active material layer, and a first electrode tab, the second electrode comprises a second current collector, a second active material layer, and a second electrode tab, the first electrode tab comprises a first(a) electrode tab and a first(b) electrode tab, the second electrode tab comprises a second(a) electrode tab and a second(b) electrode tab, the first(a) electrode tab and the second(a) electrode tab are disposed furthest from the core part, and the first(a) electrode tab comprises a region with a regional width less than a tab width of the first(b) electrode tab

In some examples, the width of all areas of the first(a) electrode tab is less than the width of the first(b) electrode tab.

In some examples, a length of the first(a) electrode tab can be longer than a length of the first(b) electrode tab.

In some examples, the second(a) electrode tab comprises a second region with a second region width less than a second tab width of the second(b) electrode tab.

In some examples, the width of all areas of the second(a) electrode tab is less than the width of the second(b) electrode tab.

In some examples, a length of the second(a) electrode tab is longer than a length of the above second(b) electrode tab.

In some examples, shapes of the first(a) electrode tab and the first(b) electrode tab are different from one another, and shapes of the second(a) electrode tab and the second(b) electrode tab are different from one another.

In some examples, the tab width of the first(a) electrode tab decreases toward the first active material layer, and the second tab width of the second(a) electrode tab decreases toward the second active material layer.

In some examples, the first(a) electrode tab comprises a first-first(a) electrode tab and a first-second(a) electrode tab, the second(a) electrode tab comprises a second-first(a) electrode tab and a second-second(a) electrode tab, the first-first(a) electrode tab is closer to the first active material layer than the first-second(a) electrode tab, the second-first(a) electrode tab is closer to the second active material layer than the second-second(a) electrode tab, a first-first(a) width of the first-first(a) electrode tab is less than a first-second(a) width of the first-second(a) electrode tab, and a second-first(a) width of the second-first(a) electrode tab is less than a second-second(a) width of the second-second(a) electrode tab.

In some examples, the first(a) electrode tab comprises a plurality of first tabs spaced apart from each other, the second(a) electrode tab comprises a plurality of second tabs spaced apart from each other, a first tabs width of the plurality of first tabs is less than the tab width of the first(b) electrode tab, and a second tabs width of the plurality of second tabs is less than the second tab width of the second(b) electrode tab.

In some examples, the electrode assembly further comprises a heat dissipation layer disposed on at least one of the first(a) electrode tab and the second(a) electrode tab.

In some examples, the tab width of the first(b) electrode tab and the second tab width of the second(b) electrode tab are 5 mm or more.

In some examples, the first(a) electrode tab comprises a first region having a first regional width of 20% to 50% of the tab width of the first(b) electrode tab, and the second(a) electrode tab comprises a second region having a second regional width of 20% to 50% of the second tab width of the second(b) electrode tab.

In some examples, the secondary battery according to the embodiment includes a case; an electrode assembly accommodated in the case; a first lead connected to the first electrode tab; and a second lead connected to the second electrode tab.

In some examples, the electrode assembly comprises a first end where winding of the first electrode, the second electrode, and the separator starts and a second end where the winding ends, the first(a) electrode tab is at least one of a first tab located when moving from the second end to the first end or a second tab located when moving from the second end to the first end in a state before the electrode assembly is wound, and the second(a) electrode tab is at least one of a first tab located when moving from the second end to the first end or a second tab located when moving from the second end to the first end in a state before the electrode assembly is wound.

In some examples, the first(b) electrode tab is disposed between the first end and the first(a) electrode tab before the electrode assembly is wound, and the second(b) electrode tab is disposed between the first end and the second(a) electrode tab before the electrode assembly is wound.

In some examples, the first(a) electrode tab comprises a first(a’) electrode tab and a first(a’’) electrode tab, the first(a’) electrode tab is closer to the second end than the first(a’’) electrode tab, and the width of the first(a’) electrode tab is less than the width of the first(a’’) electrode tab.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing an example of a secondary battery according to an embodiment.

FIG. 2 is a top view showing an example of an electrode assembly according to the embodiment after winding.

FIG. 3 is a side view showing an example of the electrode assembly according to the embodiment before winding.

FIGS. 4, 5, 6, 7, 8 and 9 are other side views showing examples of the electrode assembly according to the embodiment before winding.

FIGS. 10 and 11 are cross-sectional views showing examples taken along the A-A' and B-B' sections of FIG. 9.

FIG. 12 is another side view showing an example of the electrode assembly according to the embodiment before winding.

FIGS. 13 and 14 are perspective views showing an example of a battery pack including battery modules according to some embodiments.

FIGS. 15 and 16 are perspective views and a side view showing an example of a vehicle including battery packs according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

Hereinafter, an electrode assembly and a secondary battery according to an embodiment will be described with reference to the drawings. The secondary battery may be classified into a cylindrical shape, a prismatic shape, a pouch shape, or a coin shape according to its shape. The secondary battery described below may be applied to a pouch-type secondary battery.

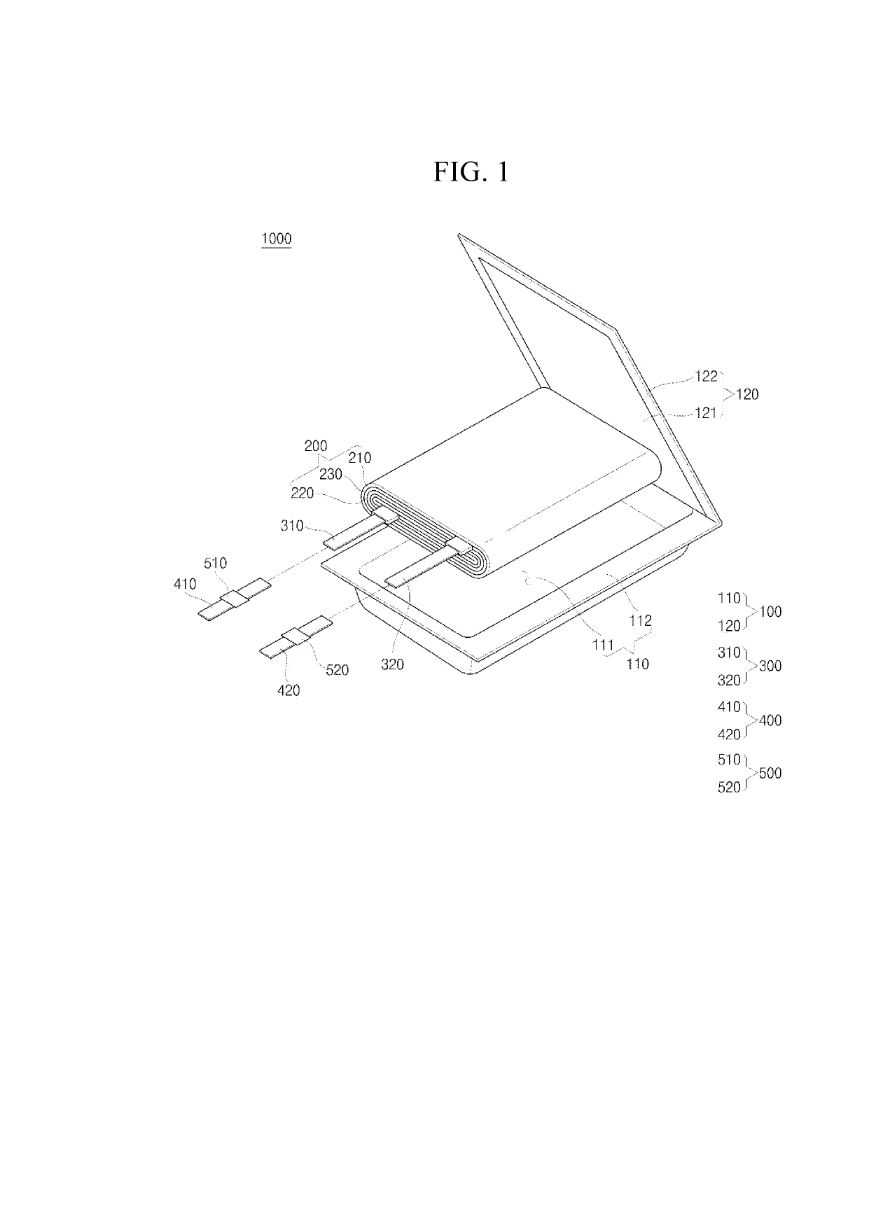

Referring to FIGS. 1 to 5, a secondary battery 1000 according to an embodiment may include a case 100 and an electrode assembly 200.

The case 100 may include an accommodation part 110 and a cap part 120. The accommodation part 110 and the cap part 120 may be connected. The case 100 may be formed in a pouch shape.

The accommodation part 110 may include a concave part 111 and a first sealing part 112. The accommodation part 110 may include an accommodating space. Specifically, the accommodation part 110 may include an internal bottom surface and an inner surface formed by the concave part 111. The accommodating space may be formed by the bottom surface and the inner surface.

The first sealing part 112 may be disposed at the edge of the accommodation part 110. A sealing layer may be disposed on the first sealing part 112.

The cap part 120 may include a cover part 121 and a second sealing part 122.

The cover part 121 may cover the accommodation part 110. Specifically, the cover part 121 may cover the electrode assembly 200 accommodated in the accommodation part 110.

The second sealing part 122 may be disposed at the edge of the cap part 120. The sealing layer may be disposed on the second sealing part 122. The first sealing part 112 and the second sealing part 122 may overlap each other. Specifically, when the accommodation part 110 is covered by the cap part 120, the first sealing part 112 and the second sealing part 122 may face each other. Thus, the accommodation part 110 and the cap part 120 may be bonded by the sealing layer.

The electrode assembly 200 may be accommodated in the case 100. Specifically, the electrode assembly 200 may be accommodated in the accommodating space of the case. Specifically, the electrode assembly 200 may be accommodated in the accommodating space together with the electrolyte.

As illustrated, one electrode assembly is accommodated in the case. However, the embodiment is not limited thereto. Two or more electrode assemblies may be accommodated in the case.

The electrode assembly 200 may include a first electrode 210, a second electrode 220, and a separator 230. The electrode assembly 200 may be formed by winding the first electrode 210, the second electrode 220, and the separator 230. For example, the electrode assembly 200 may be formed by winding the first electrode 210, the second electrode 220, and the separator 230 in a jelly roll shape. Accordingly, the electrode assembly 200 may include a core part 250.

The first electrode 210 may include a first current collector and a first active material layer. The first current collector may include a metal foil such as aluminum or an aluminum alloy. The first active material layer may include a transition metal oxide. For example, the first electrode 210 may be a positive electrode.

The first electrode 210 may be connected to the first electrode tab 310. The first active material layer is not disposed on the first electrode tab 310. The first electrode tab 310 may be welded to the first current collector. In some embodiments, the first electrode tab 310 may be formed integrally with the first current collector. For example, the first current collector may include a first uncoated portion on which the first active material layer is not disposed. The first uncoated portion may be notched to form a plurality of first substrate tabs. The first substrate tab may be the first electrode tab 310. Accordingly, the first electrode tab 310 may include the same material as the first current collector.

The first electrode tab 310 may include a plurality of first electrode tabs. The plurality of first electrode tabs may be welded to each other.

The second electrode 220 may include a second current collector and a second active material layer. The second current collector may include materials such as a metal foil such as copper, a copper alloy, nickel, or a nickel alloy. The second active material layer may include graphite or carbon. For example, the second electrode 220 may be a negative electrode.

The second electrode 220 may be connected to the second electrode tab 320. The second active material layer is not disposed on the second electrode tab 320. The second electrode tab 320 may be welded to the second current collector. In some embodiments, the second electrode tab 320 may be formed integrally with the second current collector. For example, the second current collector may include a second uncoated portion on which the second active material layer is not disposed. The second uncoated portion may be notched to form a plurality of second substrate tabs. The second substrate tabs may be the second electrode tabs 320. Accordingly, the second electrode tabs 320 may include the same material as the second current collector.

The second electrode tabs 320 may include a plurality of second electrode tabs. The plurality of second electrode tabs may be welded to each other.

The separator 230 functions to prevent short circuiting between the first electrode 210 and the second electrode 220 while allowing movement of lithium ions. The separator 230 may include a polyethylene film, a polypropylene film, or a polyethylene-polypropylene film.

The first electrode tab 310 and the second electrode tab 320 may each be connected to a lead. For example, the first electrode tab 310 may be connected to the first lead 410. The first electrode tab 310 may be connected to the first external terminal by the first lead 410. The second electrode tab 320 may be connected to the second lead 420. The second electrode tab 320 may be connected to the second external terminal by the second lead 420. The first lead 410 may include the same material as the first electrode tab. In addition, the second lead 420 may include the same material as the second electrode tab.

An insulating layer 500 may be disposed on the lead. Specifically, the insulating layer may be disposed on a portion of the lead. The insulating layer may be disposed to surround the lead. For example, a first insulating layer 510 may be disposed on the first lead 410. A second insulating layer 520 may be disposed on the second lead 420. The lead 400 may be insulated from the case 100 by the insulating layer 500.

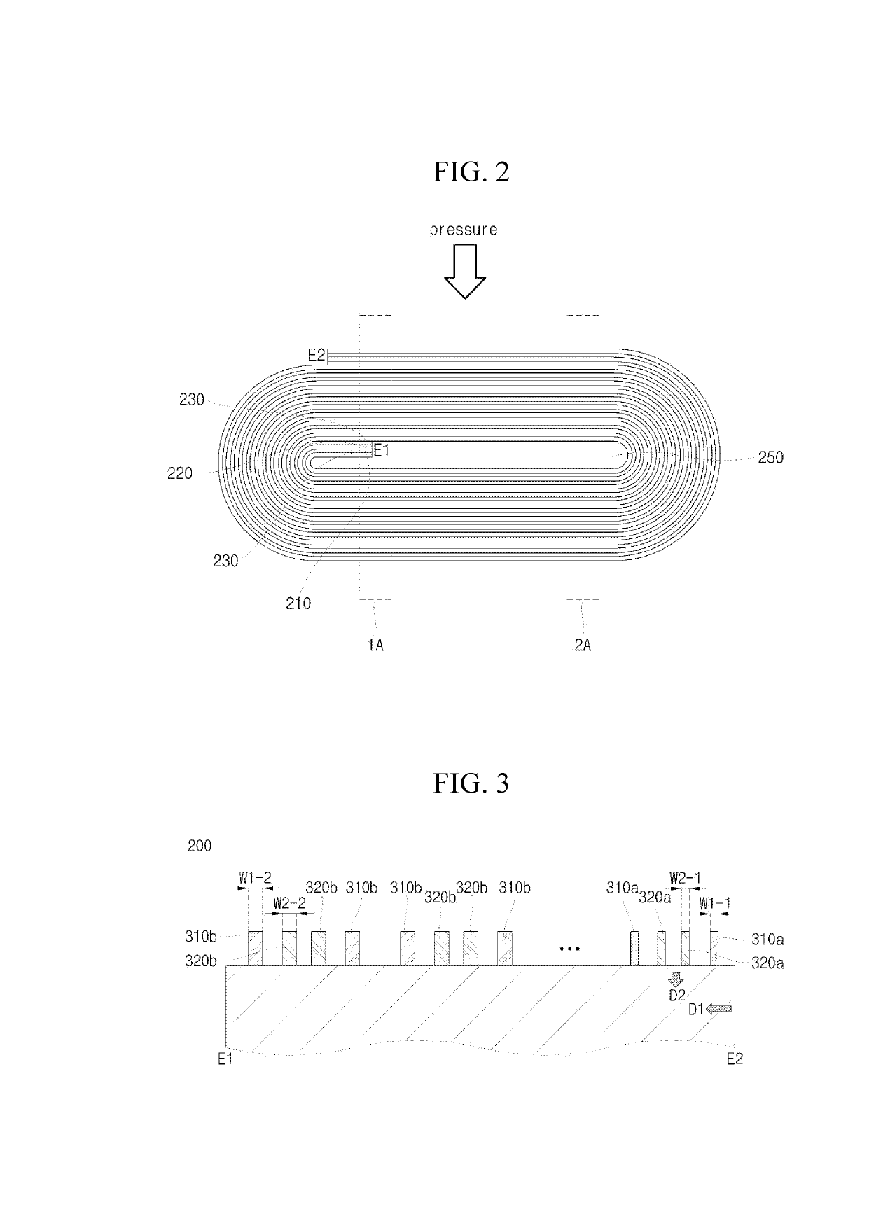

As described above, the electrode assembly 200 may be wound in a jellyroll shape. Referring to FIG. 2, the electrode assembly 200 is wound from the first end E1 to the second end E2. Thus, the first end E1 may be a winding end where winding starts, and the second end E2 may be a winding end where winding ends. Subsequently, the electrode assembly 200 can be pressurized. Accordingly, the electrode assembly 200 may be deformed into a shape that can be accommodated in the case 100.

The first electrode tab 310 and the second electrode tab 320 are disposed at different positions. For example, the first electrode tab 310 may be disposed in the first region 1A, and the second electrode tab 320 may be disposed in the second region 2A.

Since the electrode assembly has a jelly roll shape, the plurality of electrode tabs are disposed at different positions. For example, the electrode tab 300 may include a first tab and a second tab. The first tab may be a tab furthest from the core part 250. The first tab may be a tab disposed at the last turn of the electrode assembly. The second tab may be a tab between the core part 250 and the first tab.

The electrode tab 300 includes metal. Accordingly, when the secondary battery is exposed to a high temperature, heat may move along the electrode tab. The first electrode tab 310 or the second electrode tab 320 may include a first tab positioned close to the second end E2. That is, the electrode tab positioned in the first region may include a first tab positioned close to the second end E2. Accordingly, the separator adjacent to the first tab may contract due to heat. Accordingly, the end of the separator may contract. Accordingly, the first electrode and the second electrode may be short-circuited in the region adjacent to the first tab.

In addition, the electrode assembly 200 is pressed after being wound in a jellyroll shape. The pressing process is performed by pressing the outer side of the electrode assembly. Accordingly, the tension of the separator positioned at the outermost side of the electrode assembly is reduced. The outermost separator is a separator positioned at the last turn of the electrode assembly. Accordingly, the outermost separator may be well contracted by heat. Thus, the first electrode and the second electrode may be short-circuited in the last turn of the electrode assembly.

FIGS. 3 to 9 are side views of the electrode assembly before winding. Hereinafter, an embodiment in which the first electrode tab 310 is disposed in the first region and the second electrode tab 320 is disposed in the second region will be described. However, the embodiment is not limited thereto. The following description may also be applied to an embodiment in which the second electrode tab 320 is disposed in the first region and the first electrode tab 310 is disposed in the second region.

The first electrode tab 310 may include a first(a) electrode tab 310a and a first(b) electrode tab 310b. The first(a) electrode tab 310a may be disposed at the last turn of the electrode assembly. The first(a) electrode tab 310a may be the tab furthest from the core part. The first(a) electrode tab 310a may be a tab adjacent to the second end E2 before the electrode assembly is wound. That is, the first(a) electrode tab 310a may be at least one of a first tab located when moving from the second end E2 to the first end E1 (i.e. the first tab encountered when moving from the second end E2 towards the first end E1, regardless of any empty space/region between the first tab and the second end E2), or a second tab located when moving from the second end E2 to the first end E1 (i.e., the second tab encountered when moving from the second end E2 towards the first end E1) before the electrode assembly is wound. For example, the first(a) electrode tab 310a may be two tabs adjacent to the second end E2 before the electrode assembly is wound. The first(b) electrode tab 310b may be a tab between the first(a) electrode tab 310a and the first end E1 before the electrode assembly is wound.

The second electrode tab 320 may include a second(a) electrode tab 320a and a second(b) electrode tab 320b. The second(a) electrode tab 320a may be disposed at the last turn of the electrode assembly. The second(a) electrode tab 320a may be a tab furthest from the core part. The second(a) electrode tab 320a may be a tab adjacent to the second end E2 before the electrode assembly is wound. That is, the second(a) electrode tab 320a may be at least one tab adjacent to the second end E2 before the electrode assembly is wound. For example, the second(a) electrode tab 320a may be two tabs adjacent to the second end E2 before the electrode assembly is wound. The second(b) electrode tab 320b may be a tab between the second(a) electrode tab 320a and the first end E1 before the electrode assembly is wound.

The electrode tabs may have different sizes. Specifically, the first(a) electrode tab 310a and the first(b) electrode tab 310b may have different sizes. For example, the first(a) electrode tab may include a region having a width less than that of the first(b) electrode tab. For example, a partial or entire region of the first(a) electrode tab may be less than a width of the first(b) electrode tab. In addition, the second(a)electrode tab 320a and the second(b) electrode tab 320b may have different sizes. For example, the second(a) electrode tab may include a region having a width less than that of the second(b) electrode tab. For example, a partial or entire region of the second(a) electrode tab may be less than a width of the second(b) electrode tab.

Referring to FIG. 3, the first(a) electrode tab 310a may have a first-first width W1-1. The first(b) electrode 310b tab may have a first-second width W1-2. The first-first width W1-1 may be less than the first-second width W1-2. For example, the first-second width W1-2 may be 5 mm or more. For example, the first-first width W1-1 may be 20% to 50% of the first-second width W1-2. For example, a partial or entire region of the first(a) electrode tab may be 20% to 50% of the width of the first(b) electrode tab.

In addition, the second(a) electrode tab 320a may have a second-first width W2-1. The second(b) electrode tab 320b may have a second-second width W2-2. The second-first width W2-1 may be less than the second-second width W2-2. For example, the second-second width W2-2 may be 5 mm or more. For example, the second-first width W2-1 may be 20% to 50% of the second-second width W2-2. For example, a partial or entire region of the second(a) electrode tab may be 20% to 50% of the width of the second(b) electrode tab.

The separator 230 may be contracted by heat. The separator 230 may be contracted in multiple directions. Specifically, the separator may be contracted in the first direction D1 and the second direction D2. In the state before the electrode assembly is wound, the first direction D1 is the length direction, and the second direction D2 is the width direction.

For example, the separator 230 may be contracted in the first direction D1 and the second direction D2 by the first(a) electrode tab 310a that is closest to the second end E2. The separator 230 may be contracted in the second direction D2 by the first(a) electrode tab 310a and the second(a) electrode tab (320a). The separator adjacent to the second end E2 may be easily contracted compared to other regions because the tension is reduced during the process. That is, the separator 230 may be contracted in the first direction D1 and the second direction D2 by the heat transferred from the first(a) electrode tab 310a and the second(a) electrode tab 320a.

Thus, the widths of the first(a) electrode tab 310a and the second(a) electrode tab 320a are formed small. Since the first(a) electrode tab 310a is formed small, the heat transferred to the separator through the first(a) electrode tab is reduced. Thus, the contraction of the separator 230 in the first direction D1 and the second direction D2 may be reduced.

In addition, since the second(a) electrode tab 320a is formed small, the heat transferred to the separator through the second(a) electrode tab is reduced. Accordingly, the contraction of the separator 230 in the second direction D2 may be reduced.

In addition, the widths of the first(b) electrode tab 310b and the second(b) electrode tab 320b are formed to be large. Accordingly, a sufficient amount of current may move to the first electrode and the second electrode. Accordingly, the performance of the secondary battery may be prevented from being reduced due to an increase in resistance.

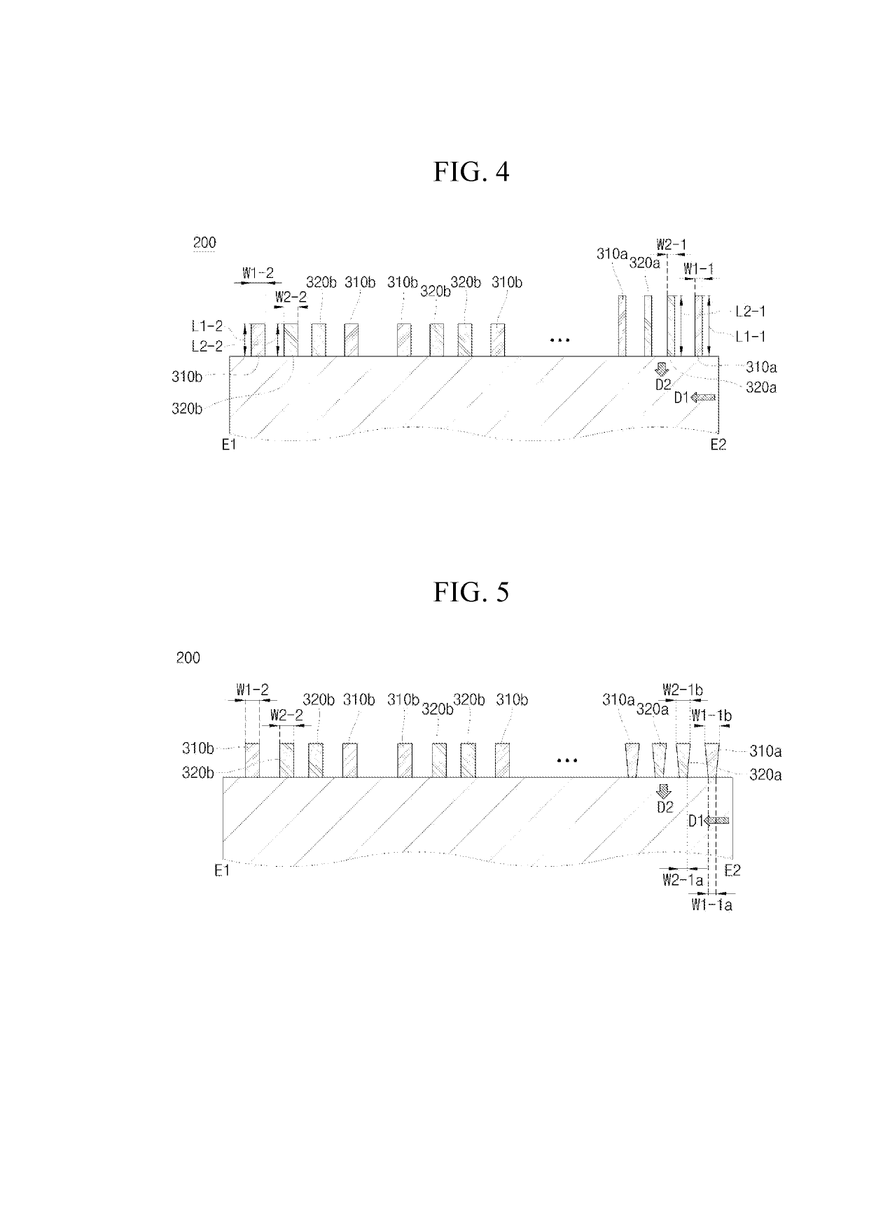

Referring to FIG. 4, the electrode tabs may have different lengths. Specifically, the first(a) electrode tab 310a and the first(b) electrode tab 310b may have different lengths.

The first(a) electrode tab may have a first-first length L1-1. The first(b) electrode tab may have a first-second length L1-2. The first-first length L1-1 may be longer than the first-second length L1-).

In addition, the second(a) electrode tab 320a and the second(b) electrode tab 320b may have different lengths.

The second(a) electrode tab may have a second-first length L2-1. The second(b) electrode tab may have a second-second length L2-2. The second-first length L2-1 may be longer than the second-second length L2-2.

The heat transferred to the separator 230 may vary depending on the boundary region between the electrode tab and the separator. Specifically, when the size of the boundary region between the electrode tab and the separator is small, the heat transferred to the separator may be reduced.

Accordingly, the widths of the first(a) electrode tab 310a and the second(a) electrode tab 320a are formed small. Accordingly, the contraction of the separator 230 in the first direction D1 and the second direction D2 may be reduced or prevented.

In addition, the lengths of the first(a) electrode tab 310a and the second(a) electrode tab 320a are formed long. Accordingly, the first(a) electrode tab 310a and the first(b) electrode tab (310b) may have the same or similar areas. In addition, the second(a) electrode tab 320a and the second(b) electrode tab 320b may have the same or similar areas.

Thus, the current moving to the first electrode and the second electrode may become uniform. Accordingly, since the reaction of the first active material layer and the second active material layer becomes uniform, the performance of the secondary battery may be improved.

Referring to FIG. 5, the first(a) electrode tab 310a and the first(b) electrode tab 310b may have different shapes. The first(a) electrode tab 310a may include one end and another end opposite to the one end. The one end may be a boundary between the first(a) electrode tab 310a and the first active material layer. The width of the first(a) electrode tab 310a may decrease from the other end to the one end. That is, the width of the first(a) electrode tab 310a may decrease while approaching the first active material layer. For example, the one end may have a first-first(a) width W1-1a, and the other end may have a first-first(b) width W1-1b. The first-first(a) width W1-1a may be less than the first-first(b) width W1-1b. The first-first(b) width W1-1b may be the same as or similar to the first-second width W1-2. For example, the first(a) electrode tab 310a may have an inverted trapezoidal shape.

The second(a) electrode tab 320a may include one end and an opposite end to the one end. The one end may be a boundary between the second(a) electrode tab 320a and the second active material layer. The width of the second(a) electrode tab 320a may decrease from the other end to the one end. That is, the width of the second(a) electrode tab 320a may decrease while approaching the second active material layer. For example, the one end may have a second-first(a) width W2-1a, and the other end may have a second-first(b) width W2-1b. The second-first(a) width W2-1a may be less than the second-first(b) width W2-1b. The second-first(b) width W2-1b may be the same as or similar to the second-second width W2-2. For example, the second(a) electrode tab 320a may have an inverted trapezoidal shape.

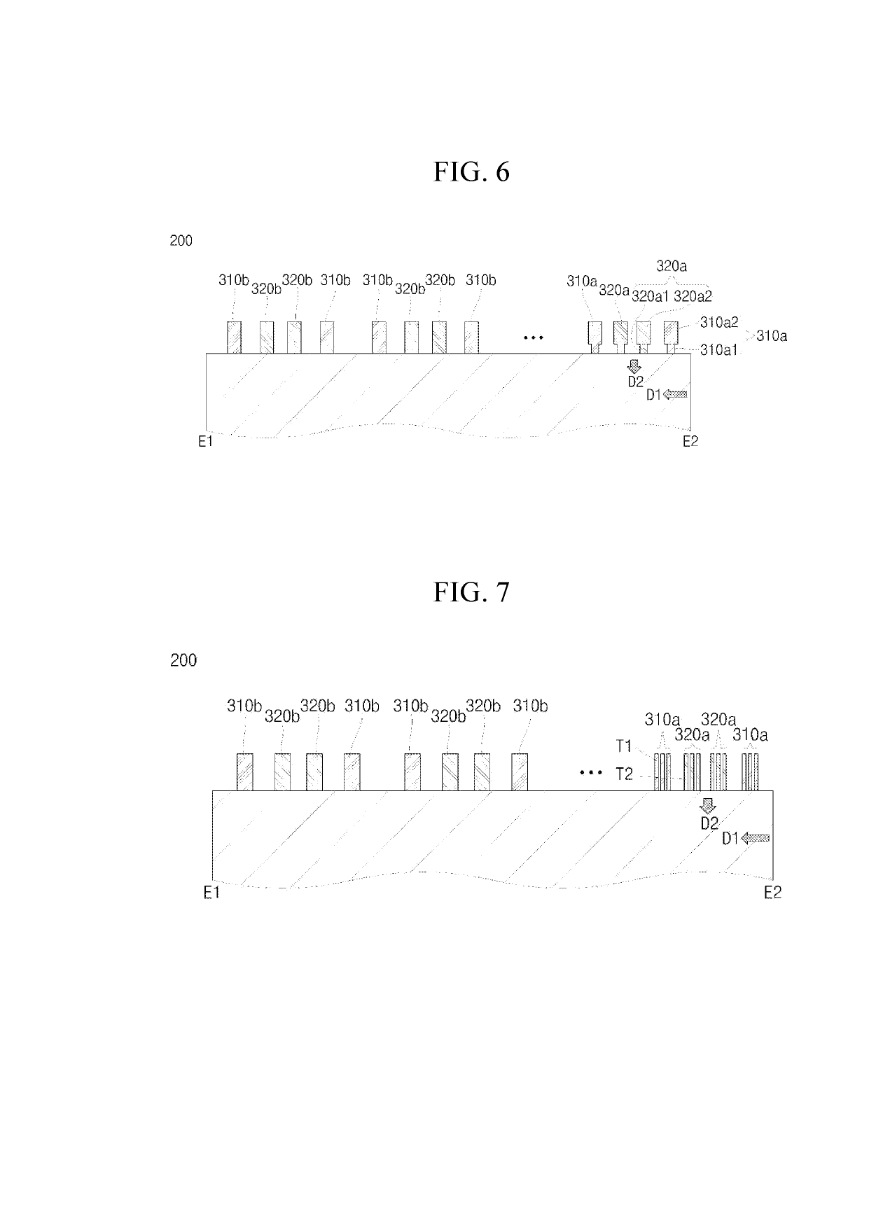

Referring to FIG. 6, the first(a) electrode tab 310a and the first(b) electrode tab 310b may have different shapes. The first(a) electrode tab may include a first-first(a) electrode tab 310a1 and a first-second(a) electrode tab 310a2. The first-first(a) electrode tab 310a1 may be closer to the first active material layer than the first-second(a) electrode tab 310a2. The first-first(a) electrode tab 310a1 and the first-second(a) electrode tab 310a2 may have different sizes. Specifically, the width of the first-first(a) electrode tab 310a1 may be less than the width of the first-second(a) electrode tab 310a2. The length of the first-first(a) electrode tab 310a1 and the length of the first-second(a) electrode tab 310a2 may be the same or different.

The second(a) electrode tab 320a and the second(b) electrode tab 320b may have different shapes. The second(a) electrode tab may include the second-first(a) electrode tab 320a1 and the second-second(a) electrode tab 320a2. The second-first(a) electrode tab 320a1 may be closer to the second active material layer than the second-second(a) electrode tab 320a2. The second-first(a) electrode tab 320a1 and the second-second(a) electrode tab 320a2 may have different sizes. Specifically, the width of the second-first(a) electrode tab 320a1 may be less than the width of the second-second(a) electrode tab 320a2. The length of the second-first(a) electrode tab 320a1 and the length of the second-second(a) electrode tab 320a2 may be the same or different.

The heat transferred to the separator 230 may vary depending on the boundary region between the electrode tab and the separator. Specifically, when the size of the boundary region between the electrode tab and the separator is small, the heat transferred to the separator may be reduced.

Accordingly, the widths of one end of the first(a) electrode tab 310a and the second(a) electrode tab 320a are formed small. In some embodiments, the width of the first-first(a) electrode tab 310a1 is less than the width of the first-second(a) electrode tab 310a2. In some embodiments, the width of the second-first(a) electrode tab 320a1 is less than the width of the second-second(a) electrode tab 320a2. Accordingly, heat moving from the electrode tab to the separator may be reduced. Accordingly, contraction of the separator 230 in the first direction D1 and the second direction D2 may be reduced or prevented.

In addition, the widths of the other ends of the first(a) electrode tab 310a and the second(a) electrode tab 320a are formed large. In some embodiments, the widths of the first-second(a) electrode tab 310a2 and the second-second(a) electrode tab 320a2 are formed large. Accordingly, the first(a) electrode tab 310a and the first(b) electrode tab 310b may have similar areas. In addition, the second(a) electrode tab 320a and the second(b) electrode tab 320b may have similar areas.

Accordingly, the current moving to the first electrode and the second electrode may become uniform. Accordingly, since the reaction of the first active material layer and the second active material layer becomes uniform, the performance of the secondary battery may be improved.

Referring to FIG. 7, the first(a) electrode tab 310a and the second(a) electrode tab 320a may include a plurality of tabs. For example, the first(a) electrode tab 310a may include a plurality of first tabs T1. The first tabs T1 may be spaced apart from each other. The second(a) electrode tab 320a may include a plurality of second tabs T2. The second tabs T2 may be spaced apart from each other. The width of the first tab T1 may be less than the width of the first(b) electrode tab 310b. In addition, the width of the second tab T2 may be less than the width of the second(b) electrode tab 320b.

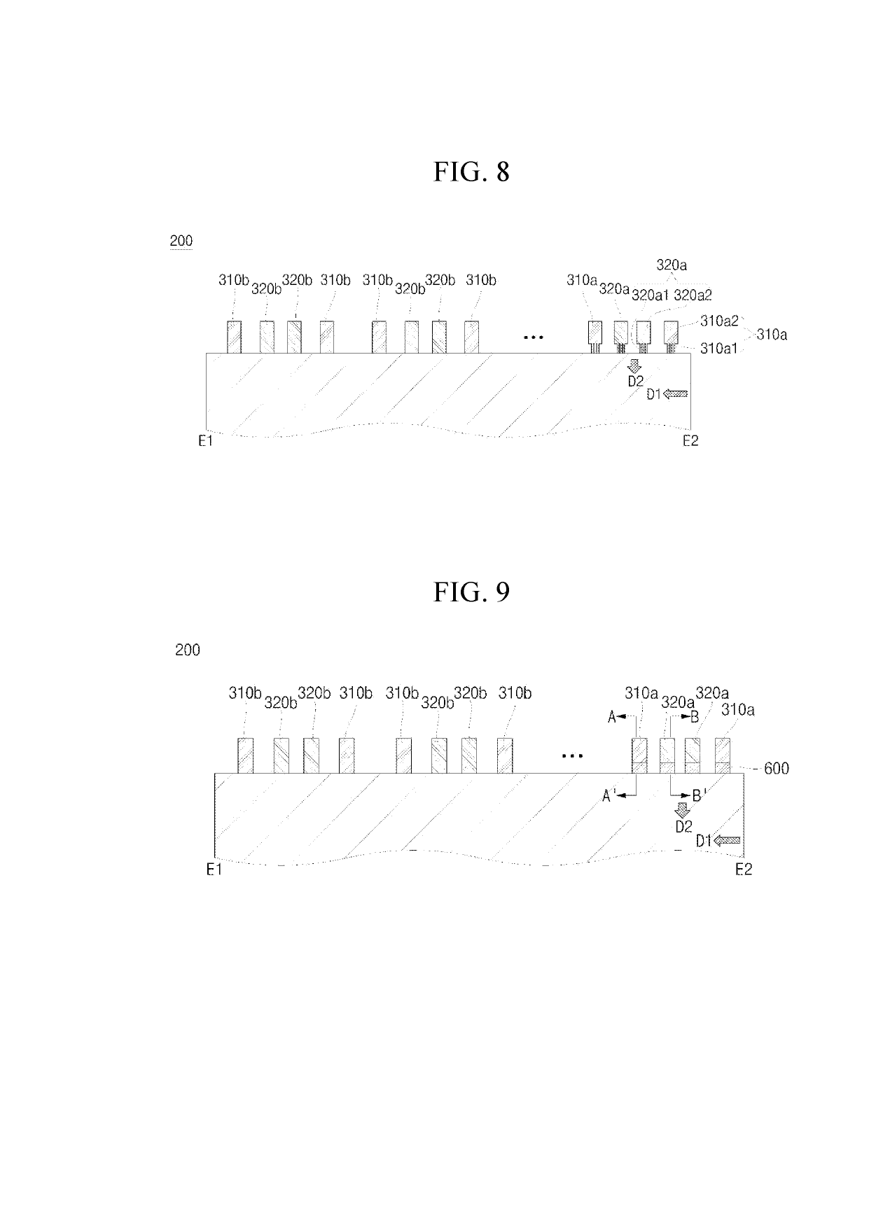

Referring to FIG. 8, the first-first(a) electrode tab 310a1 and the second-first(a) electrode tab 320a1 may include a plurality of tabs. The plurality of tabs may be spaced apart from each other.

The heat transferred to the separator 230 may vary depending on the boundary region between the electrode tab and the separator. Specifically, when the size of the boundary region between the electrode tab and the separator is small, the heat transferred to the separator may be reduced.

Accordingly, the first(a) electrode tab 310a may include a plurality of first tabs, and the second(a) electrode tab 320a may include a plurality of second tabs. In some embodiments, the first-first(a) electrode tab 310a1 and the second-first(a) electrode tab 320a1 may include a plurality of tabs. Accordingly, the heat transferred from the electrode tab to the separator may be reduced. Accordingly, the contraction of the separator 230 in the first direction D1 and the second direction D2 may be reduced or prevented.

Referring to FIGS. 9 to 11, the first(a) electrode tab 310a and the first(b) electrode tab 310b may have the same or similar sizes. In addition, the second(a) electrode tab 320a and the second(b) electrode tab 320b may have the same or similar sizes.

A heat dissipation layer 600 may be disposed on at least one of the first(a) electrode tab 310a or the first(b) electrode tab 320b. The heat dissipation layer 600 may include a metal or a resin. For example, the heat dissipation layer 600 may be disposed on at least one of the upper or lower surfaces of the first(a) electrode tab 310a. In addition, the heat dissipation layer 600 may be disposed on at least one of the upper or lower surfaces of the second(a) electrode tab 320a.

The heat dissipation layer 600 is not disposed on the other ends of the first(a) electrode tab 310a and the second(a) electrode tab 320a. In addition, the heat dissipation layer 600 is not disposed in a region adjacent to the other ends of the first(a) electrode tab 310a and the second(a) electrode tab 320a. The other ends of the first(a) electrode tab 310a and the second(a) electrode tab 320a are portions that are welded with other electrode tabs. Accordingly, the heat dissipation layer may be disposed in a region adjacent to one end of the first(a) electrode tab 310a and the second(a) electrode tab 320a.

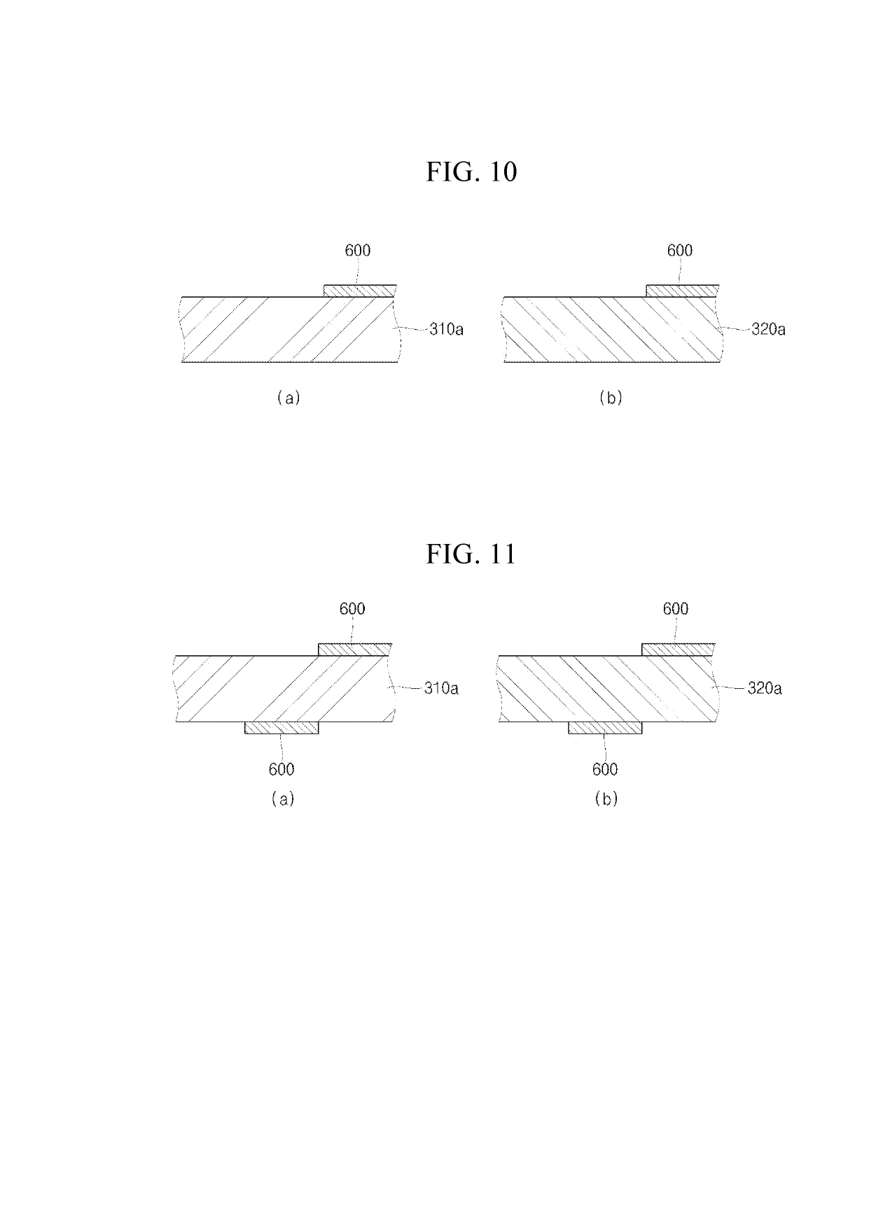

For example, referring to FIG. 10, the heat dissipation layer 600 may be disposed on the upper surface or lower surface of the first(a) electrode tab 310a. In addition, the heat dissipation layer 600 may be disposed on the upper surface or lower surface of the second(a) electrode tab 320a.

In some embodiments, referring to FIG. 11, the heat dissipation layer 600 may be disposed on the upper surface and lower surface of the first(a) electrode tab 310a. In addition, the heat dissipation layer 600 may be disposed on the upper surface and lower surface of the second(a) electrode tab 320a.

The heat dissipation layers on the upper surface and lower surface may overlap in the thickness direction of the electrode tab. In some embodiments, the heat dissipation layers of the upper surface and the lower surface may not overlap in the thickness direction of the electrode tab. In some embodiments, the heat dissipation layers of the upper surface and the lower surface may partially overlap in the thickness direction of the electrode tab.

The heat moving to the separator 230 through the first(a) electrode tab 310a and the first(b) electrode tab 320b may be reduced by the heat dissipation layer 600. Accordingly, the contraction of the separator in the first direction D1 and the second direction D2 may be reduced or prevented.

In addition, the first(a) electrode tab 310a and the first(b) electrode tab 310b may have similar areas. In addition, the second(a) electrode tab 320a and the second(b) electrode tab 320b may have similar areas.

Thus, the current moving to the first electrode and the second electrode may be uniform. In addition, because the reaction of the first active material layer and the second active material layer becomes uniform, the performance of the secondary battery may be improved.

The heat dissipation layer may also be applied to the structure of FIGS. 3 to 8 described above. Accordingly, the contraction of the separator may be reduced more effectively.

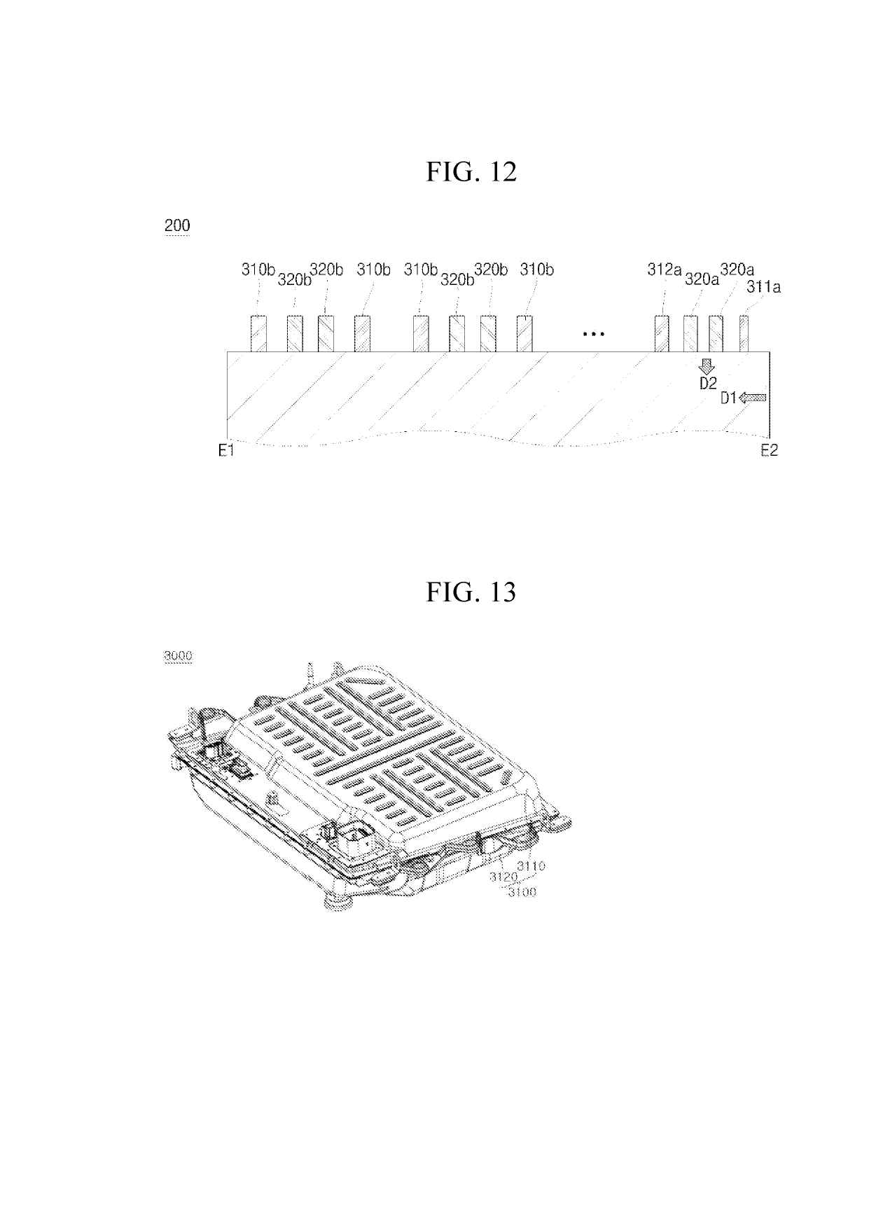

Referring to FIG. 12, the first(a) electrode tab 310a may include a first(a’) electrode tab 311a close to the second end E2 and a first(a’’) electrode tab 312a far from it.

The sizes of the first(a’) electrode tab 311a and the first(a’’) electrode tab 312a may be different. For example, the width of the first(a’) electrode tab 311a may be less than the width of the first(a’’) electrode tab 312a. In addition, the width of the first(a’’) electrode tab 311a may be less than the width of the second(a) electrode tab 320a. In addition, the width of the first(a’’) electrode tab 312a may be the same as or similar to the width of the second(a) electrode tab 320a.

The separator adjacent to the first(a’) electrode tab 311a may contract in the first direction D1 and the second direction D2. Accordingly, the separator adjacent to the first(a’’) electrode tab 312a and the second(a) electrode tab 320a may contract more. Accordingly, the width of the first(a’) electrode tab 311a may be less than the widths of the first(a’’) electrode tab 312a and the second(a) electrode tab 320a.

Accordingly, the contraction of the separator adjacent to the first(a’) electrode tab 311a in the first direction D1 and the second direction D2 may be reduced.

The electrode assembly according to the embodiment includes a plurality of electrode tabs. The electrode assembly is wound in a jellyroll shape.

The size of the electrode tabs may vary depending on the location. Specifically, the size of the electrode tab disposed in the last turn of the electrode assembly may be less than the size of the other electrode tabs. For example, the width of the electrode tab disposed in the last turn of the electrode assembly may be less than the width of the other electrode tabs.

After the electrode assembly is wound in a jellyroll shape, a pressurizing process is performed. Accordingly, the tension of the separator disposed in the last turn of the electrode assembly may be less than in other regions. Accordingly, the separator disposed in the last turn of the electrode assembly may be easily contracted by heat.

Accordingly, the embodiment forms the electrode tab disposed in the last turn of the electrode assembly small. Accordingly, the heat moving to the separator through the electrode tab may be reduced. Accordingly, the first electrode and the second electrode may be reduced or prevented from being short-circuited by the contraction of the separator.

Accordingly, the secondary battery may be prevented from exploding due to the short-circuit. Accordingly, the secondary battery may have improved safety.

The secondary battery may be used in portable small electronic devices such as smartphones, feature phones, notebook computers, digital cameras, and camcorders. In addition, the battery module and battery pack including a plurality of secondary batteries may be used as a power source for driving a motor of a hybrid vehicle or an electric vehicle and as a battery for power storage.

The secondary batteries described above may constitute the battery module. For example, the battery module may include a plurality of secondary batteries. The plurality of secondary batteries may be connected to each other in series, parallel, or series/parallel by a bus bar.

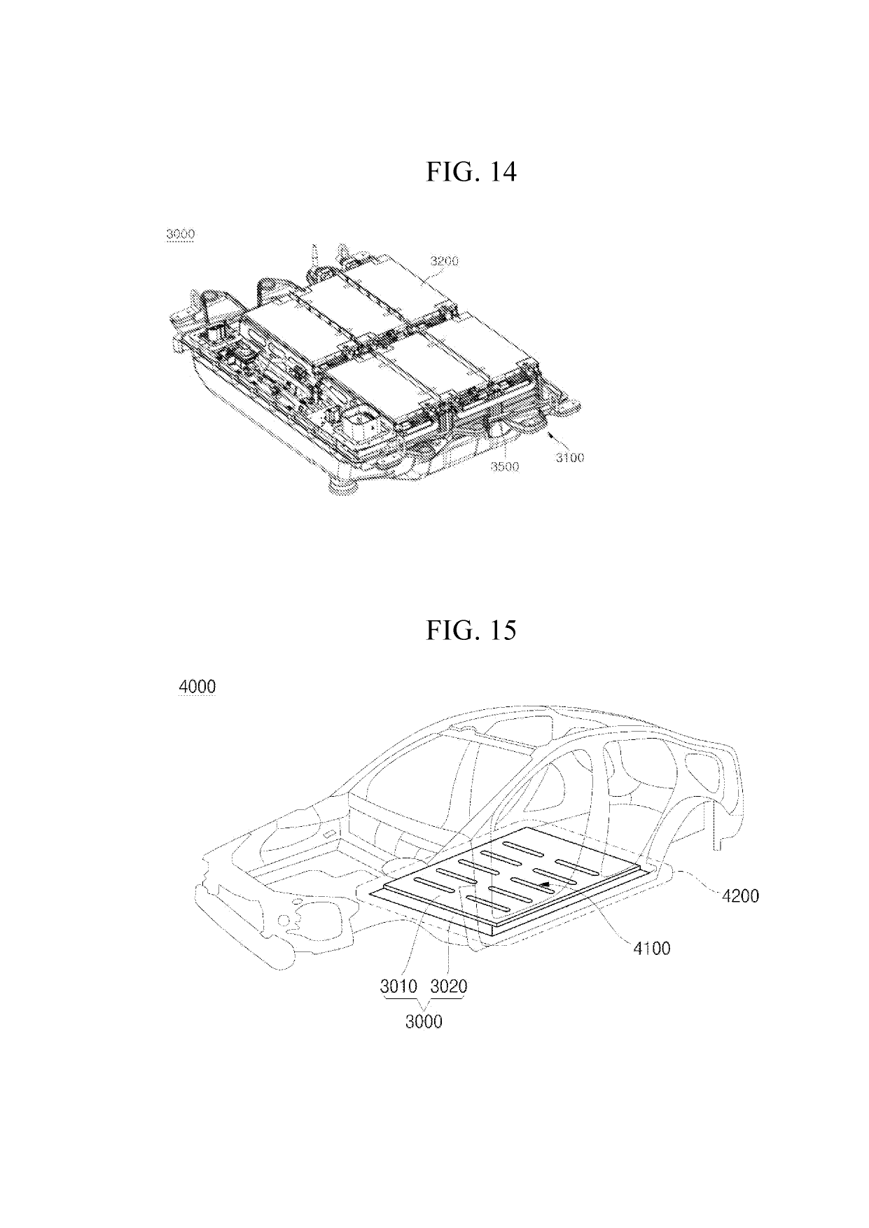

FIGS. 13 and 14 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 15, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

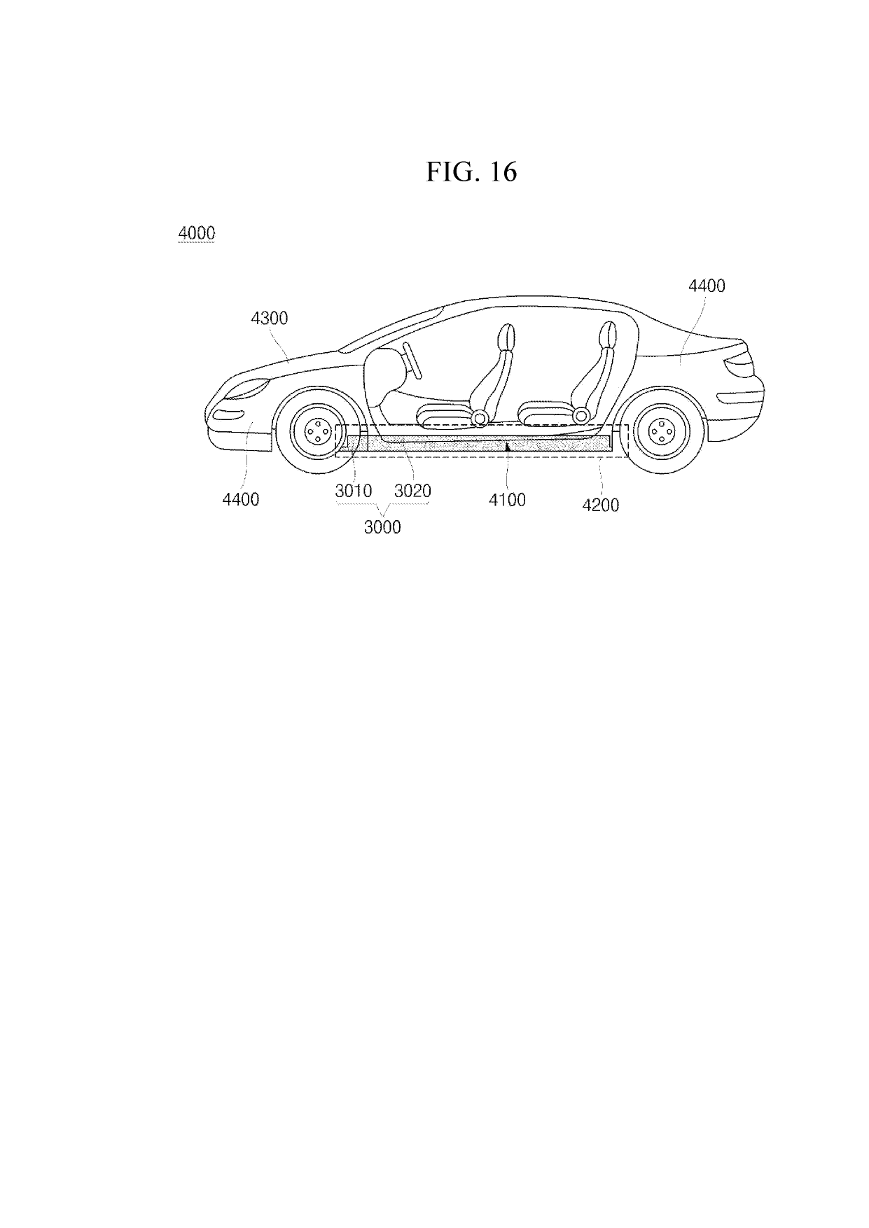

In FIG. 16, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

What is claimed is:

1. An electrode assembly comprising:
a first electrode;
a second electrode; and
a separator between the first electrode and the second electrode,
wherein the first electrode, the second electrode, and the separator are wound to form a core part;
wherein the first electrode comprises:
a first current collector;
a first active material layer; and
a first electrode tab;
wherein the second electrode comprises:
a second current collector;
a second active material layer; and
a second electrode tab;
wherein the first electrode tab comprises:
a first(a) electrode tab; and
a first(b) electrode tab;
wherein the second electrode tab comprises:
a second(a) electrode tab; and
a second(b) electrode tab;
wherein the first(a) electrode tab and the second(a) electrode tab are disposed furthest from the core part; and
wherein the first(a) electrode tab comprises a region with a regional width less than a tab width of the first(b) electrode tab.

2. The electrode assembly as claimed in claim 1, wherein the width of all areas of the first(a) electrode tab is less than the width of the first(b) electrode tab.

3. The electrode assembly as claimed in claim 2, wherein a length of the first(a) electrode tab is longer than a length of the first(b) electrode tab.

4. The electrode assembly as claimed in claim 2, wherein the second(a) electrode tab comprises a second region with a second region width that is less than a second tab width of the second(b) electrode tab.

5. The electrode assembly as claimed in claim 4, wherein the width of all areas of the second(a) electrode tab is less than the width of the second(b) electrode tab.

6. The electrode assembly as claimed in claim 5, wherein a length of the second(a) electrode tab is longer than a length of the above second(b) electrode tab.

7. The electrode assembly as claimed in claim 4, wherein shapes of the first(a) electrode tab and the first(b) electrode tab are different from one another, and
wherein shapes of the second(a) electrode tab and the second(b) electrode tab are different from one another.

8. The electrode assembly as claimed in claim 7, wherein the tab width of the first(a) electrode tab decreases toward the first active material layer, and
wherein the second tab width of the second(a) electrode tab decreases toward the second active material layer.

9. The electrode assembly as claimed in claim 7,
wherein the first(a) electrode tab comprises:
a first-first(a) electrode tab; and
a first-second(a) electrode tab;
wherein the second(a) electrode tab comprises:
a second-first(a) electrode tab; and
a second-second(a) electrode tab;
wherein the first-first(a) electrode tab is closer to the first active material layer than the first-second(a) electrode tab;
wherein the second-first(a) electrode tab is closer to the second active material layer than the second-second(a) electrode tab;
wherein a first-first(a) width of the first-first(a) electrode tab is less than a first-second(a) width of the first-second(a) electrode tab; and
wherein a second-first(a) width of the second-first(a) electrode tab is less than a second-second(a) width of the second-second(a) electrode tab.

10. The electrode assembly as claimed in claim 4,
wherein the first(a) electrode tab comprises a plurality of first tabs spaced apart from each other;
wherein the second(a) electrode tab comprises a plurality of second tabs spaced apart from each other;
wherein a first tabs width of the plurality of first tabs is less than the tab width of the first(b) electrode tab, and
wherein the second tabs width of the plurality of second tabs is less than the second tab width of the second(b) electrode tab.

11. The electrode assembly as claimed in claim 1, further comprising a heat dissipation layer disposed on at least one of the first(a) electrode tab and the second(a) electrode tab.

12. The electrode assembly as claimed in claim 1, wherein the tab width of the first(b) electrode tab and the second tab width of the second(b) electrode tab are 5 mm or more.

13. The electrode assembly as claimed in claim 1, wherein the first(a) electrode tab comprises a first region having a first regional width of 20% to 50% of the tab width of the first(b) electrode tab, and
wherein the second(a) electrode tab comprises a second region having a second regional width of 20% to 50% of the second tab width of the second(b) electrode tab.

14. A secondary battery comprising:
a case;
an electrode assembly of claim 1 accommodated in the case;
a first lead connected to the first electrode tab; and
a second lead connected to the second electrode tab.

15. The secondary battery as claimed in claim 14,
wherein the electrode assembly comprises:
a first end where winding of the first electrode, the second electrode, and the separator starts; and
a second end where the winding ends;
wherein the first(a) electrode tab is at least one of a first tab located when moving from the second end to the first end or a second tab located when moving from the second end to the first end in a state before the electrode assembly is wound, and
wherein the second(a) electrode tab is at least one of a first tab located when moving from the second end to the first end or a second tab located when moving from the second end to the first end in a state before the electrode assembly is wound.

16. The secondary battery as claimed in claim 14,
wherein the first(b) electrode tab is disposed between the first end and the first(a) electrode tab before the electrode assembly is wound, and
wherein the second(b) electrode tab is disposed between the first end and the second(a) electrode tab before the electrode assembly is wound.

17. The secondary battery as claimed in claim 14, wherein the first(a) electrode tab comprises:
a first(a’) electrode tab; and
a first(a’’) electrode tab;
wherein the first(a’) electrode tab is closer to the second end than the first(a’’) electrode tab; and
wherein the width of the first(a’) electrode tab is less than the width of the first(a’’) electrode tab.
